(19) United States
(12) Patent Application Publication
(10) Pub. No.: US 2017/0306260 A1
(43) Pub. Date: Oct. 26, 2017

(54) STABLE ANTIFOAMING COMPOSITIONS

(71) Applicants: Dow Global Technologies LLC, Midland, MI (US); Rohm and Haas Company, Philadelphia, PA (US)

(72) Inventors: Patrick E. Brutto, Bloomingdale, IL (US); Afua Sarpong Karikari, Bristol, PA (US); William C. Miles, Collegeville, PA (US); Christopher J. Tucker, Midland, MI (US)

(21) Appl. No.: 15/517,537

(22) PCT Filed: Oct. 16, 2015
(86) PCT No.: PCT/US2015/055881

§ 371 Date: Apr. 7, 2017

Related U.S. Application Data
(60) Provisional application No. 62/066,498, filed on Oct. 21, 2014.

(51) Int. Cl. C10M 145/14; C10M 173/00; C10M 125/18; C10M 155/02; C08L 23/08; B01D 19/04

(52) U.S. Cl. CPC C10M 145/14; C08L 23/0876; B01D 19/0409; C10M 125/18; C10M 155/02; C10M 173/00; C08L 2205/03; C10M 2209/084; C10M 2229/047; C10N 2220/021; C10N 2230/18; C10N 2240/40; C10M 2201/081

(57) ABSTRACT

A stabilized antifoaming composition having at least three components. The first component is an antifoaming agent. The second component is an ethylene-(meth)acrylic acid copolymer. The third component is a salt.

This invention relates to antifoaming compositions which are stable when dispersed in aqueous media.

U.S. Pat. No. 6,569,924 describes solubilizing agents for antifoaming compositions. These solubilizing agents are alkoxylated compounds. However, this reference does not describe how to form stable antifoaming compositions.

### STATEMENT OF INVENTION

The present invention provides a stabilized antifoaming composition, said composition comprising: (a) an antifoaming agent; (b) an ethylene-(meth)acrylic acid copolymer; and (c) a salt.

### DETAILED DESCRIPTION

Percentages are weight percentages (wt %) and temperatures are in ° C., unless specified otherwise. Operations were performed at room temperature (20-25° C.), unless specified otherwise. Weight percentages of components are based on weights of active ingredients, e.g., weight of surfactant molecules without any water that may be in a commercial surfactant product, and on the weight of the entire antifoaming composition, including water. Percentages of ethylene, (meth)acrylic acid or crosslinker units in the copolymer are based on total weight of the polymer chains. The term “(meth)acrylic” means methacrylic or acrylic.

Preferably, the antifoaming agent is an organically modified siloxane polymer, an ethylene oxide-propylene oxide copolymer or an organophosphorus compound. Preferably, the organically modified siloxane polymer is dimethyl polysiloxane, diethyl polysiloxane, dipropyl polysiloxane, methyl ethyl polysiloxane, dioctyl polysiloxane, diethyl polysiloxane, methyl propyl polysiloxane, dibutyl polysiloxane or dodecyl polysiloxane; preferably dimethyl polysiloxane. The organically modified siloxane polymer may contain mixtures of different alkyl groups. Preferably, organically modified siloxane polymers have from 30 to 1000 siloxane units, preferably 40 to 500. Preferably, the organophosphorus compound is a phosphate or phosphite having three alkyl or aryl substituents, each substituent having from three to ten carbon atoms; preferably n-tri-butyl phosphate, n-tributoxyethyl phosphate, triphenylphosphite, or a mixture thereof. Preferably, the ethylene oxide-propylene oxide copolymer is a block copolymer, preferably one having Mn from 1,000 to 10,000.

Preferably, the ethylene-(meth)acrylic acid copolymer comprises from 50 to 90 wt % ethylene and 10 to 50 wt % (meth)acrylic acid; preferably at least 55 wt % ethylene, preferably at least 60 wt %, preferably at least 65 wt %, preferably at least 70 wt %, preferably at least 75 wt %; preferably no more than 85 wt % ethylene, preferably no more than 82 wt %, preferably no more than 79 wt %, preferably no more than 76 wt %; preferably, at least 15 wt % (meth)acrylic acid, preferably at least 18 wt %, preferably at least 21 wt %; preferably no more than 45 wt % (meth)acrylic acid, preferably no more than 40 wt %, preferably no more than 35 wt %, preferably no more than 30 wt %, preferably no more than 25 wt %. Preferably, the ethylene-(meth)acrylic acid copolymer is an ethylene-acrylic acid copolymer.

Preferably, the number-average molecular weight (Mn) of the ethylene-(meth)acrylic acid copolymer is from 2,000 to 20,000; preferably from 2,500 to 15,000; preferably from 3,000 to 10,000. Preferably, the weight-average molecular weight (Mw) of the ethylene-(meth)acrylic acid copolymer is from 8,000 to 150,000; preferably from 10,000 to 100,000; preferably from 12,000 to 60,000; preferably from 14,000 to 30,000. Preferably, the ethylene-(meth)acrylic acid copolymer is partially neutralized, i.e., from 50 to 100 mole % of the (meth)acrylic acid carboxylic acid groups is neutralized by addition of a base (i.e., in the salt form), preferably at least 70%, preferably at least 80%, preferably at least 85%, preferably at least 88%; preferably no more than 96%, preferably no more than 94%. Preferably, the base is an alkali metal hydroxide, preferably sodium or potassium hydroxide, preferably potassium hydroxide. Preferably, the amount of crosslinker in the ethylene-(meth)acrylic acid copolymer is no greater than 0.15 wt %, preferably no greater than 0.1 wt %, preferably no greater than 0.05 wt %, preferably no greater than 0.02 wt %; all percentages based on dry polymer. A crosslinker is a polymerized unit of a multiethylenically unsaturated monomer or a metal ion.

Preferably, the antifoaming composition comprises from 0.05 to 3 wt % antifoaming agent(s); preferably at least 0.3 wt %, preferably at least 0.6 wt %, preferably at least 0.9 wt %, preferably at least 1.2 wt %, preferably at least 1.5 wt %; preferably no more than 2.5 wt %, preferably no more than 2.3 wt %, preferably no more than 2.1 wt %. Preferably, the antifoaming composition comprises from 0.2 to 12 wt % ethylene-(meth)acrylic acid copolymer(s); preferably at least 1.2 wt %, preferably at least 2.4 wt %, preferably at least 3.6 wt %, preferably at least 4.8 wt %, preferably at least 6 wt %; preferably no more than 10 wt %, preferably no more than 9 wt %, preferably no more than 8.5 wt %. Preferably, the weight ratio of ethylene-(meth)acrylic acid copolymer(s) to antifoaming agent(s) is from 0.5:1 to 6:1, preferably from 1:1 to 5:1, preferably from 2:1 to 5:1. Preferably, the antifoaming composition comprises at least 79 wt % water, preferably at least 81 wt %, preferably at least 83 wt %, preferably at least 85 wt %, preferably at least 87 wt %; preferably no more than 95 wt %, preferably no more than 92 wt %, preferably no more than 89 wt %.

Preferably, the antifoaming composition comprises from 1 to 6 wt % of salts; preferably at least 2 wt %, preferably at least 2.5 wt %, preferably at least 3 wt %; preferably no more than 5 wt %, preferably no more than 4.5 wt %, preferably no more than 4 wt %, preferably no more than 3.5 wt %. Preferably, salts have cations that are alkali metal or alkaline earth metal ions or protonated amines; preferably sodium, potassium, magnesium, calcium or ammonium ions or protonated amino alcohols, preferably C₂-C₈ amino alcohols. Preferably, the anions are acetates, chlorides, C₁-C₁₂ carboxylates, sulfates, phosphates or C₁-C₁₂ sulfonates and phosphonates; preferably acetates or chlorides; preferably acetates. Preferably, the salts are alkali metal acetates; preferably sodium or potassium acetate. Preferably, the salt concentration in the composition is from 0.1-2 M, preferably from 0.2 to 1.5 M, preferably from 0.3 to 1 M. The composition may contain a mixture of salts.

Preferably, the antifoaming composition comprises from 0.5 to 6 wt % of surfactants; preferably at least 1 wt %, preferably at least 1.5 wt %, preferably at least 2 wt %, preferably at least 2.5 wt %, preferably at least 3 wt %; preferably no more than 5 wt %, preferably no more than 4.5 wt %. Preferably, the surfactant(s) are nonionic surfactants or anionic surfactants, preferably nonionic surfactants. Preferably, nonionic surfactants have an alkyl group having at least eight carbon atoms and at least five polymerized ethylene oxide or propylene oxide residues. Preferably, nonionic surfactants have at least six polymerized ethylene oxide units, preferably at least seven, preferably at least eight, preferably at least nine; preferably no more than twelve, preferably no more than eleven, preferably no more than ten. Optionally, nonionic surfactants have polymerized units of propylene oxide, preferably between the alkyl group and the ethylene oxide units. Preferably, nonionic surfactants have a C₁₀-C₁₈ alkyl group, preferably C₁₂-C₁₆. Preferably, the ratio of surfactant concentration to ethylene-(meth)acrylic acid copolymer concentration is from 0.05:1 to 2:1, preferably 0.1:1 to 1.5:1, preferably 0.2:1 to 1:1.

Preferably, the antifoaming agent and the ethylene-(meth)acrylic acid copolymer are combined first, followed by the salt. If surfactant is part of the antifoaming composition, it is added after the salt.

Preferably, the pH of the antifoaming composition is from 7 to 11. Suitable bases to adjust the pH of the formulation include mineral bases such as sodium hydroxide and potassium hydroxide; ammonium hydroxide; and organic bases such as mono-, di- or tri-ethanolamine; or 2-dimethylamino-2-methyl-1-propanol (DMAMP). Mixtures of bases may be used. Suitable acids to adjust the pH of the aqueous medium include mineral acid such as hydrochloric acid, phosphorus acid, and sulfuric acid; and organic acids such as acetic acid. Mixtures of acids may be used. The formulation may be adjusted to a higher pH with base and then back titrated to the ranges described above with acid.

In one preferred embodiment of the invention, the antifoaming composition is added to a metalworking fluid concentrate. Stability of the antifoaming agent against phase separation is important when portions of the concentrate are removed and further diluted for use as metalworking fluid. Preferably, the concentration of the antifoaming composition in the metalworking fluid concentrate is from 1 to 10 wt %, preferably from 2 to 9 wt %. Dilution of the antifoaming composition to a lower ionic strength in the metalworking fluid is believed to release the antifoaming agent from encapsulation with the copolymer and make it available as an active antifoaming agent. Metalworking fluids typically are at least 40 wt % water. Preferably, the concentration of the antifoaming agent in the metalworking fluid is from 0.01 to 0.2 wt %.

### EXAMPLES

Formulation of 2 wt % antifoam (ALDRICH Antifoam B: water, α-methyl-ω-methoxypolydimethylsiloxane, cellulose methyl ether, and hydrogenated tallow glycerides.), 8 wt % PRIMACOR (Ecosmooth Satin: Mn=4,780, Mw=31,380, 80% ethylene, ˜85% neutralized with NaOH), 3.2 wt % NaCl, 4 wt % GENAPOL C-100 (C₁₆-C₁₈ with 10 moles ethylene oxide), and 82.8 wt % water was made by mixing first the antifoam and the polymer, then adding a 3.2 wt % solution of NaCl. Finally, GENAPOL C-100 was dissolved in a 3.2 wt % NaCl solution and added. Order of addition is critical in these steps. This formulation is called the defoamer concentrate.

The defoamer concentrate was added to a low oil semi-synthetic metalworking fluid (MWF) that consisted of (all wt %), 2% CORFREE M1, 47% DI water, 7% CORRGUARD EXT, 4% CORRGUARD 95, 10% HYDROCAL 100, 14% PETRONATE HL, 8% L5, 2.4% Actrafos 110, 3% DOWANOL PnB, and 2.2% GENAPOL C-100. The final defoamer concentration in the MWF concentrate was 0.05 wt %. A separate MWF was made containing 0.05 wt % Antifoam B without any other materials. Foam tests were conducted over time to determine whether the PRIMACOR polymer was able to stabilize the defoamer in the MWF concentrate.

Foam tests were conducted by measuring out 5 g samples of the MWF concentrate at the indicated times after preparation of the concentrate and adding it to 95 g of DI water. The vessel was capped and the solution was gently mixed until it was uniform. At that point, the solution was poured gently into a blender and run at high for 15 seconds. The solution was then poured into a 250 mL graduated cylinder and the foam volume remaining was measured 195 seconds after the blender was turned on.

% Foam Reduction from Control

| Days after | Antifoam | Stabilized |
|---|---|---|
| Formulation | Only | Antifoam |
| 1 | 31% | 33% |
| 5 | 24% | 33% |
| 9 | 24% | 33% |
| 14 | 14% | 24% |

Particle sizes of the samples were determined by dynamic light scattering (DLS) measurements conducted with a Malvern ZETASIZER NanoZS particle analyzer (Malvern Instruments Ltd., Malvern, U.K.) at a wavelength of 633 nm from a 4.0 mW, solid-state He-Ne laser at a scattering angle of 173° and at 25+/−0.1° C. The stabilized particle was suspended in a solution of 3.2 wt % sodium hydroxide at an antifoam concentration of approximately 0.1 mg/mL. The sample was then pipetted into a clean polystyrene cuvette. The average of three separate measurements was used to generate the particle size histograms. The particle size of the same sample was measured once every 5 minutes for the extended time experiments. The results are tabulated below.

| Particle Size | Stabilized | Antifoam 1 | Stabilized | Antifoam 2 |
|---|---|---|---|---|
| radius (nm) | Antifoam 1 | Only | Antifoam 2 | Only |
| 7.843 | 0 | 0 | 0 | 0 |
| 9.083 | 0 | 0 | 0 | 0 |
| 10.52 | 0 | 0 | 9.5 | 0 |
| 12.18 | 0 | 0 | 28.1 | 0 |
| 14.11 | 0 | 0 | 32.5 | 0 |
| 16.34 | 0 | 0 | 19.9 | 0 |
| 18.92 | 0 | 0 | 7.8 | 0 |
| 21.91 | 0 | 0 | 1.9 | 0 |
| 25.37 | 0 | 0 | 0.2 | 0 |
| 29.39 | 0 | 0 | 0 | 0 |
| 34.03 | 0 | 0 | 0 | 0 |
| 39.41 | 0 | 0 | 0 | 0 |
| 45.64 | 0 | 0 | 0 | 1.5 |
| 52.85 | 1.7 | 0 | 0 | 8.3 |
| 61.21 | 7.6 | 0 | 0 | 18.2 |
| 70.89 | 15.1 | 0 | 0 | 22 |
| 82.09 | 18.4 | 0 | 0 | 18.4 |
| 95.07 | 16.8 | 0 | 0 | 12.7 |
| 110.1 | 13.6 | 0 | 0 | 8.2 |
| 127.5 | 10.3 | 0 | 0 | 5.1 |
| 147.7 | 7.3 | 0 | 0 | 3 |
| 171 | 4.7 | 0 | 0 | 1.6 |
| 198 | 2.7 | 0 | 0 | 0.7 |
| 229.3 | 1.3 | 0.6 | 0 | 0.3 |
| 265.6 | 0.5 | 10.4 | 0 | 0.1 |
| 307.6 | 0.2 | 29 | 0 | 0 |
| 356.2 | 0 | 34.3 | 0 | 0 |
| 412.5 | 0 | 20 | 0 | 0 |
| 477.7 | 0 | 5.4 | 0 | 0 |
| 553.2 | 0 | 0.3 | 0 | 0 |
| 640.7 | 0 | 0 | 0 | 0 |
| 741.9 | 0 | 0 | 0 | 0 |

In both cases (Antifoams 1 and 2, Antifoam 1 is Antifoam B supplied by Sigma Aldrich and Antifoam 2 is Munzing FOAMBAN HP710), the particle size of the antifoam was reduced significantly upon stabilization. This indicates that the polymer is stabilizing smaller particles than the emulsifier that was incorporated into the antifoam product.

The following table contains the results of an experiment examining how the particle size changes with time. Only one measurement was taken for the antifoam only for two reasons. First, it is clearly larger than stabilized antifoam, as shown in the previous chart. Second, for systems where aggregation is taking place, size measurements from light scattering over time are not reliable. Many of the assumptions made in the particle size calculations break down in aggregating systems. Thus, it is important to confirm whether or not there is sedimentation on the bottom of the vial following any sort of light scattering measurement and to examine the actual raw data for signs of sedimentation. In this case, no signs of sedimentation were seen on the bottom of the vial or from the software for the stabilized antifoam, but both were observed for the control antifoam.

Intensity Average Diameter (nm)

| Time (min) | Stabilized Antifoam | Antifoam Only |
|---|---|---|
| 0 | 226.1 | 1039 |
| 5 | 216.5 | NM |
| 10 | 210.5 | NM |
| 15 | 222.2 | NM |
| 20 | 204 | NM |
| 25 | 217.5 | NM |
| 30 | 202 | NM |
| 35 | 201.7 | NM |
| 40 | 197.4 | NM |
| 45 | 198 | NM |
| 50 | 198.3 | NM |
| 55 | 196.4 | NM |
| 60 | 194.1 | NM |
| 65 | 196.8 | NM |
| 70 | 195.8 | NM |
| 75 | 196.8 | NM |
| 80 | 194.9 | NM |
| 85 | 199.9 | NM |
| 90 | 191.7 | NM |
| 95 | 192.9 | NM |
| 100 | 190.4 | NM |
| 105 | 193.5 | NM |
| 110 | 190.5 | NM |
| 115 | 205.7 | NM |
| 120 | 196.8 | NM |
| 125 | 191.2 | NM |
| 130 | 192.8 | NM |
| 135 | 195.1 | NM |
| 140 | 191.4 | NM |
| 145 | 196 | NM |

1. A stabilized antifoaming composition, said composition comprising: (a) an antifoaming agent; (b) an ethylene-(meth)acrylic acid copolymer; and (c) a salt.

2. The composition of claim 1 in which a weight ratio of ethylene-(meth)acrylic acid copolymer to antifoaming agent is from 0.5:1 to 6:1

3. The composition of claim 2 in which the antifoaming agent is a siloxane or a copolymer of ethylene oxide and propylene oxide.

4. The composition of claim 3 in which the ethylene-(meth)acrylic acid copolymer comprises from 50 to 90 wt % ethylene and 10 to 50 wt % (meth)acrylic acid.

5. The composition of claim 4 in which from 50 to 100 mole % of the (meth)acrylic acid is neutralized.

6. The composition of claim 5 comprising from 0.5 to 6 wt % of surfactants.

7. The composition of claim 6 comprising from 0.05 to 3 wt % antifoaming agent and from 0.2 to 12 wt % ethylene-(meth)acrylic acid copolymer.

8. The composition of claim 7 comprising from 79 to 95 wt % water and from 1 to 6 wt % salts.

9. The composition of claim 8 in which the copolymer comprises ethylene and acrylic acid.
